(19) United States
(12) Patent Application Publication
(10) Pub. No.: US 2024/0015308 A1
(43) Pub. Date: Jan. 11, 2024

(54) APPARATUS AND METHOD FOR VIDEO ENCODING AND DECODING

(71) Applicants: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(72) Inventors: Sea Nae Park, Seoul (KR); Joo Hyung Byeon, Seoul (KR); Dong Gyu Sim, Seoul (KR); Seung Wook Park, Yongin-si (KR)

(73) Assignees: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(21) Appl. No.: 18/038,468

(22) PCT Filed: Nov. 23, 2021
(86) PCT No.: PCT/KR2021/017319

§ 371 Date: May 24, 2023

(30) Foreign Application Priority Data
Nov. 24, 2020 (KR) 10-2020-0158995
Nov. 23, 2021 (KR) 10-2021-0162670

(51) Int. Cl. H04N 19/176; H04N 19/70; H04N 19/172

(52) U.S. Cl. CPC H04N 19/176; H04N 19/70; H04N 19/172

(57) ABSTRACT

A method for decoding a target block which has been encoded in an intra block copy (IBC) mode. The method comprises: determining a partition type of the target block by decoding at least one of a first syntax element for determining a reference area to refer to in order to partition the target block and a second syntax element related to the partition type of the target block; decoding block vector information regarding one or more sub-blocks, which have been partitioned from the target block according to the partition type, and determining a block vector corresponding to each of the sub-blocks by using the block vector information; and predicting the target block by generating and combining one or more prediction blocks from a current picture in which the target block is located by using the block vector corresponding to each of the sub-blocks.

### CROSS-REFERENCE TO RELATED APPLICATION

This application is a U.S. national stage of International Application No. PCT/KR2021/017319, filed on Nov. 23, 2021, which claims priority to Korean Patent Application No. 10-2020-0158995 filed on Nov. 24, 2020, and Korean Patent Application No. 10-2021-0162670 filed on Nov. 23, 2021, the entire disclosures of each of which are incorporated herein by reference.

### TECHNICAL FIELD

The present disclosure relates to an apparatus and a method for video encoding and decoding.

### BACKGROUND

The statements in this section merely provide background information related to the present disclosure and do not necessarily constitute prior art.

Since the volume of video data is larger than that of voice data or still image data, storing or transmitting video data without processing for compression requires a lot of hardware resources including memory.

Accordingly, in storing or transmitting video data, the video data is generally compressed using an encoder so as to be stored or transmitted. Then, a decoder receives the compressed video data and decompresses and reproduces the video data. Compression techniques for such video include Video Versatile Coding VVC, which improves coding efficiency over High Efficiency Video Coding HEVC by about 30%, as well as H.264/AVC and HEVC.

However, the sizes, resolutions, and frame rates of pictures are getting gradually higher, and therefore the volume of data to be encoded is also increasing. Thus, a new compression technique is required for offering better encoding efficiency and a significant improvement in picture quality compared to existing compression techniques. In particular, there is a need for a compression technique that can encode pictures with a complex texture more efficiently, such as pictures containing edges (boundaries between objects) that vary in direction due to the presence of various objects.

### SUMMARY

The present disclosure provides a method of encoding/decoding a target block in an intra block copy (IBC) mode by using block splitting into square or rectangular shapes and other various shapes. Furthermore, the present disclosure provides a method of efficiently encoding information about block splitting.

One aspect of this disclosure provides a method for decoding a target block encoded in an intra block copy (IBC) mode. The method includes: determining a splitting type of the target block by decoding at least either a first syntax element for determining a reference region to be referenced to split the target block or a second syntax element related to the splitting type of the target block. The method also includes: decoding block vector information on one or more subblocks into which the target block is split according to the splitting type; and determining block vectors respectively corresponding to the subblocks by using the block vector information. The method also includes predicting the target block by generating and combining one or more prediction blocks from a current picture where the target block is positioned, by using the block vectors respectively corresponding to the subblocks.

Another aspect of this disclosure provides a method for encoding a target block using an intra block copy (IBC) mode. The method includes determining a splitting type of the target block. The method also includes determining block vectors for one or more subblocks into which the target block is split according to the splitting type. The method also includes predicting the target block by generating and combining one or more prediction blocks from a current picture where the target block is positioned, by using the block vectors respectively corresponding to the subblocks. The method also includes encoding information on the splitting type and block vector information on the one or more subblocks. The information on the splitting type includes at least either a first syntax element for determining a reference region to be referenced to split the target block or a second syntax element related to the splitting type of the target block.

Yet another aspect of this disclosure provides a decoder-readable recording medium for storing a bitstream, which includes encoded data of a target block encoded using an intra block copy (IBC) mode and is decoded by a video decoding method. The video decoding method includes determining a splitting type of the target block by decoding at least either a first syntax element for determining a reference region to be referenced to split the target block or a second syntax element related to the splitting type of the target block. The video decoding method also includes decoding block vector information on one or more subblocks into which the target block is split according to the splitting type; and determining block vectors respectively corresponding to the subblocks by using the block vector information. The video decoding method also includes predicting the target block by generating and combining one or more prediction blocks from a current picture where the target block is positioned, by using the block vectors respectively corresponding to the subblocks.

### BRIEF DESCRIPTION OF DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a sequential chart for explaining a method of encoding a target block in the IBC mode according to an embodiment of the present disclosure.

FIG. 7 is a sequential chart for explaining a method of decoding a target block encoded in the IBC mode according to an embodiment of the present disclosure.

FIGS. 8A and 8B are views for explaining a method of determining a splitting type of a target block by using an intra-prediction mode map according to an embodiment of the present disclosure.

FIG. 9 is a view for explaining a method of generating a prediction block of a target block from block vectors corresponding to subblocks according to an embodiment of the present disclosure.

FIGS. 10A and 10B are views for explaining another method of generating a prediction block of a target block from block vectors corresponding to subblocks according to an embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, a detailed description of related known components and functions, when considered to obscure the subject of the present disclosure, has been omitted for the purpose of clarity and for brevity.

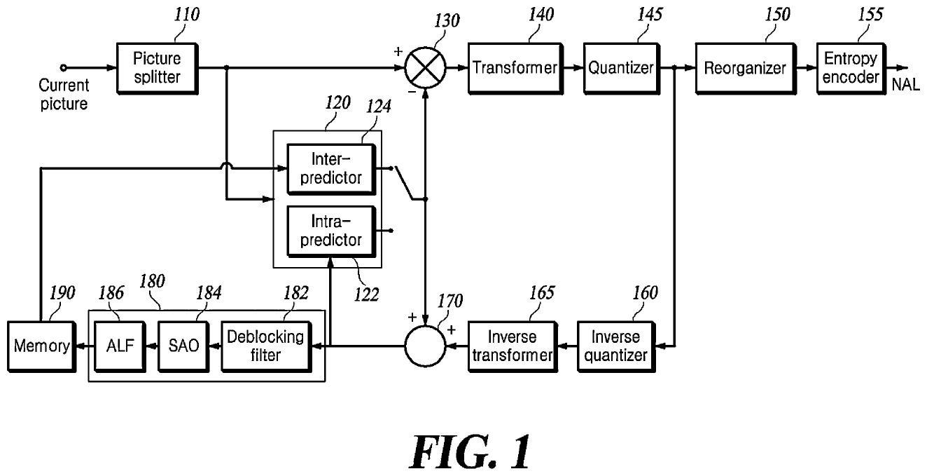

FIG. 1 is a block diagram for a video encoding apparatus, which may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as the software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each CU is encoded as a syntax of the CU and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information (CTU size) on the size of the CTU is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may be a binarytree (BT) in which the higher node is split into two lower nodes. The tree structure may be a ternarytree (TT) in which the higher node is split into three lower nodes at a ratio of 1:2:1. The tree structure may be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a BTTT is added to the tree structures to be referred to as a multiple-type tree (MTT).

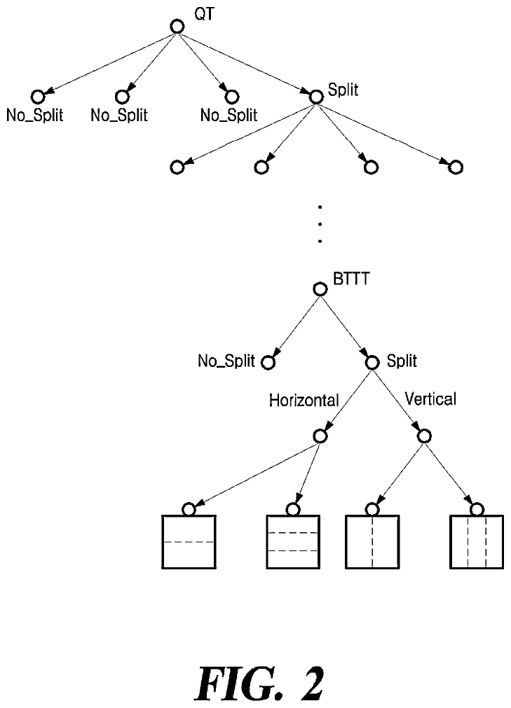

FIG. 2 is a diagram for describing a method for splitting a block by using a QTBTTT structure.

As illustrated in FIG. 2, the CTU may first split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., in a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the coding unit (CU), which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks of a form of being asymmetrical to each other may be additionally present. The asymmetrical form may include a form in which the block of the corresponding node split into two rectangular blocks having a size ratio of 1:3 or also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block”. As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

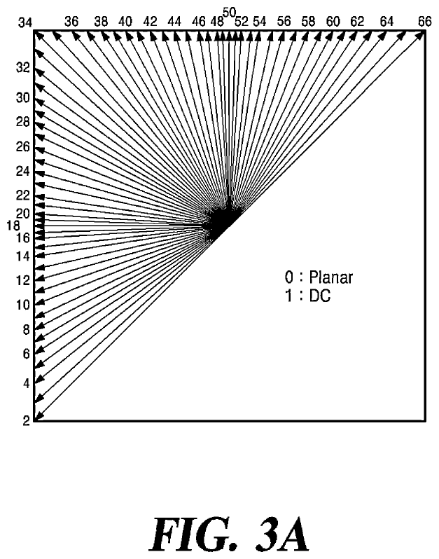

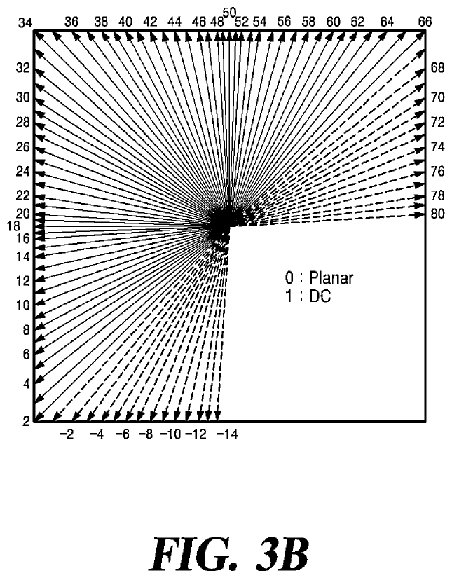

The intra predictor 122 predicts pixels in the current block by using pixels (reference pixels) positioned on a neighboring of the current block in the current picture including the current block. There is a plurality of intra prediction modes according to the prediction direction. For example, as illustrated in FIG. 3A, the plurality of intra prediction modes may include 2 non-directional modes including a planar mode and a DC mode and may include 65 directional modes. A neighboring pixel and an arithmetic equation to be used are defined differently according to each prediction mode.

For efficient directional prediction for the current block having the rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and also select an appropriate intra prediction mode to be used from tested modes. For example, the intra predictor 122 may calculate rate-distortion values by using a rate-distortion analysis for multiple tested intra prediction modes and also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current bock in the current picture and the prediction block in the reference picture. In general, motion estimation is performed for a luma component, and a motion vector calculated based on the luma component is used for both the luma component and a chroma component. Motion information including information the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, etc. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of the bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and information on two motion vectors is delivered to the entropy encoder 155. Here, reference picture list 0 may be constituted by pictures before the current picture in a display order among pre-restored pictures, and reference picture list 1 may be constituted by pictures after the current picture in the display order among the pre-restored pictures. However, although not particularly limited thereto, the pre-restored pictures after the current picture in the display order may be additionally included in reference picture list 0. Inversely, the pre-restored pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

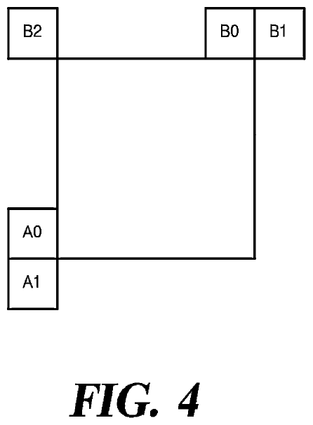

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

The merge skip mode is a special case of the merge mode. After quantization, when all transform coefficients for entropy encoding are close to zero, only the neighboring block selection information is transmitted without transmitting a residual signal. By using the merge skip mode, it is possible to achieve a relatively high encoding efficiency for images with slight motion, still images, screen content images, and the like.

Hereinafter, the merge mode and the merge skip mode are collectively called the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, etc.) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms a residual signal in a residual block having pixel values of a spatial domain into a transform coefficient of a frequency domain. The transformer 140 may transform residual signals in the residual block by using a total size of the residual block as a transform unit or also split the residual block into a plurality of subblocks and perform the transform by using the subblock as the transform unit. Alternatively, the residual block is divided into two subblocks, which are a transform area and a non-transform area to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis), and in this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to transform coefficients quantized arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), Exponential Golomb, etc.

Further, the entropy encoder 155 encodes information such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to restore the residual block.

The adder 170 adds the restored residual block and the prediction block generated by the predictor 120 to restore the current block. Pixels in the restored current block are used as reference pixels when intra-predicting a next-order block.

The loop filter unit 180 performs filtering for the restored pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the restored blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating a difference between the restored pixel and an original pixel, which occurs due to lossy coding. The SAO filter 184 applies an offset as a CTU unit to enhance a subjective image quality and encoding efficiency. Contrary to this, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The restored block filtered through the deblocking filter 182, the SAO filter 184, and the ALF 186 is stored in the memory 190. When all blocks in one picture are restored, the restored picture may be used as a reference picture for inter predicting a block within a picture to be encoded afterwards.

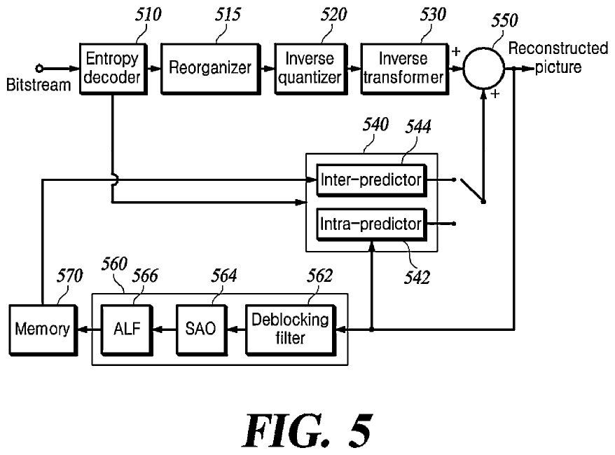

FIG. 5 is a functional block diagram for a video decoding apparatus, which may implement the technologies of the present disclosure. Hereinafter, referring to FIG. 5, the video decoding apparatus and sub-components of the apparatus are described.

The video decoding apparatus may be configured to include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for restoring the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU is extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (MTT_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT being further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information, and information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by restoring the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to restore the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include the intra predictor 542 and the inter predictor 544. The intra predictor 542 is activated when the prediction type of the current block is the intra prediction and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 restores the current block by adding the residual block output from the inverse transform unit output from the inverse transform unit and the prediction block output from the inter prediction unit or the intra prediction unit. Pixels within the restored current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the restored blocks in order to remove the blocking artifact, which occurs due to block unit decoding. The SAO filter 564 and the ALF 566 perform additional filtering for the restored block after the deblocking filtering in order to compensate a difference between the restored pixel and an original pixel, which occurs due to lossy coding. The filter coefficient of the ALF is determined by using information on a filter coefficient decoded from the bitstream.

The restored block filtered through the deblocking filter 562, the SAO filter 564, and the ALF 566 is stored in the memory 570. When all blocks in one picture are restored, the restored picture may be used as a reference picture for inter predicting a block within a picture to be encoded afterwards.

The following disclosure relates to an encoding and decoding tool, which is implemented by the above-described video encoding and decoding apparatus.

As explained above, the conventional video encoding/decoding technology employs a per-block video encoding/decoding method, and blocks are limited to a square or rectangular shape. However, since various edges exist within one picture, such as diagonal or curved ones, limiting encoding units to a square or rectangular shape causes a degradation in encoding efficiency. On the other hand, when splitting a block by a diagonal or curved line, it is necessary to encode a large volume of data in order to represent a diagonal or curved line which is a boundary by which the block is divided, and then to transmit it to the video decoding apparatus, which also may degrade encoding efficiency. Accordingly, a method for efficiently encoding splitting information is required to split a block into various shapes as well as into a square or rectangular shape.

The present disclosure to be described below provides a method of efficiently encoding pictures including edges of various directions by using a certain type of blocking splitting, in other words, geometric block splitting.

In some embodiments of the present disclosure, geometric splitting may be applied to an intra block copy (IBC) mode. Here, the IBC mode refers to a mode in which a block vector indicating the most similar block to a target block in a decoded region within a current picture including the target block is determined, and the target block is predicted using reconstructed pixels in a region indicated by the block vector. Information on the block vector is signaled from the video encoding apparatus to the video decoding apparatus. The video decoding apparatus determines the block vector from the received information on the block vector and predicts the target block by using the reconstructed pixels in the region indicated by the block vector.

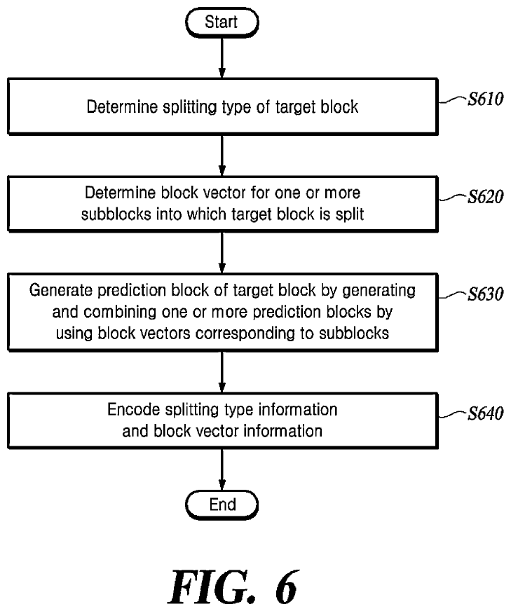

FIG. 6 is a sequential chart for explaining a method of encoding a target block in the IBC mode according to an embodiment of the present disclosure.

The video encoding apparatus determines a splitting type of a target block (S610) and determines a block vector for each of subblocks in the target block according to the determined splitting type (S620).

The video encoding apparatus generates a prediction block of the target block by generating and combining one or more prediction blocks from a reconstructed region within a current picture where the target block is positioned by using block vectors corresponding respectively to the subblocks (S630). Information on a splitting type of the target block and block vector information on the subblocks are encoded (S640). Here, the information on the splitting type includes at least either a first syntax element for determining a reference region to be referenced to split the target block or a second syntax element related to the splitting type of the target block. Also, the video encoding apparatus generates a residual block by subtracting the prediction block from the target block and encodes the residual block after transforming and quantizing the residual block.

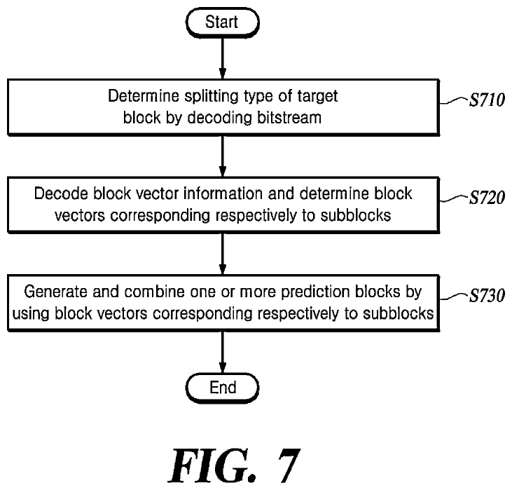

FIG. 7 is a sequential chart for explaining a method of decoding a target block encoded in the IBC mode according to an embodiment of the present disclosure.

The video decoding apparatus determines a splitting type of a target block by decoding a bitstream received from the video encoding apparatus (S710). As described above, the bitstream encoded and transmitted by the video encoding apparatus may include at least either a first syntax element or a second syntax element related to the splitting type of the target block.

Once the splitting type of the target block is determined, the video decoding apparatus decodes block vector information on one or more subblocks into which the target block is split according to the determined splitting type. Block vectors corresponding respectively to the sub blocks are determined using the block vector information (S720).

The video decoding apparatus generates a prediction block for the target block by generating and combining one or more prediction blocks within a current picture where the target block is positioned by using the block vectors of the subblocks (S730).

Afterwards, the video decoding apparatus reconstructs the target block by adding residual signals of the target block reconstructed from the bitstream and predicted pixel values in the prediction block.

Hereinafter, the steps in FIG. 7 performed by the video decoding apparatus are described in more detail. Since the video encoding apparatus needs to generate the same prediction block as the video decoding apparatus, it is apparent that the processes to be described below that are performed by the video decoding apparatus to generate the prediction block are also applied equally to the video encoding apparatus.

1. Determination of Splitting Type of Target Block

In one embodiment, the first syntax element may be used to determine a splitting type of a target block. The first syntax element may be information for indicating a reference region to be referred to within the current picture in order to split the target block. The video decoding apparatus determines a reference region within the current picture by using the first syntax element and derives the splitting type of the target block by using decoded information corresponding to the reference region.

As an example, the first syntax element may be an initial block vector indicating a reference region within the current picture. The video decoding apparatus sets a region within the current picture indicated by the initial block vector as a reference region. As another example, the first syntax element may be an index for selecting one of block vector candidates derived from decoded blocks which are decoded earlier than the target block. The decoded blocks may be the blocks neighboring the target block, which are illustrated in FIG. 4. The video decoding apparatus may select a candidate indicated by the index among the block vector candidates as an initial block vector and determine a reference region within the current picture by using the initial block vector.

Meanwhile, the decoded information corresponding to the reference region may be information showing a splitting type of the reference region. In other words, the video decoding apparatus may split the target block in the same splitting type as the reference region.

Alternatively, the decoded information corresponding to the reference region may be intra-prediction modes corresponding to the reference region. The video decoding apparatus stores intra-prediction modes for the decoded blocks within the current picture in a buffer. The intra-prediction modes may be stored for each pixel or for each block of a certain size (e.g., 4×4). The video decoding apparatus may deduce a splitting type of the target block by checking the intra-prediction modes corresponding to the reference region determined by the first syntax element and analyzing the intra-prediction modes.

For example, the video decoding apparatus may classify the intra-prediction modes into three categories: a directional mode, a non-directional mode, and an IBC mode. If the intra-prediction modes in the reference region determined by the first syntax element belong to two or more categories, the video decoding apparatus may deduce a splitting type of the target block by using a straight line or curved line for distinguishing the different categories in the reference region.

The video decoding apparatus may subdivide the directional modes into a plurality of categories by grouping modes having a similar direction among the directional modes in the reference region into one group. For example, directional modes whose angular difference is K degrees or smaller may be grouped into one category. Here, the angle K may be a fixed value that is agreed between the video encoding apparatus and the video decoding apparatus, or the angle K may be a value that is included in an SPS, a PPS, a slice header, etc. and transmitted from the video encoding apparatus to the decoding apparatus.

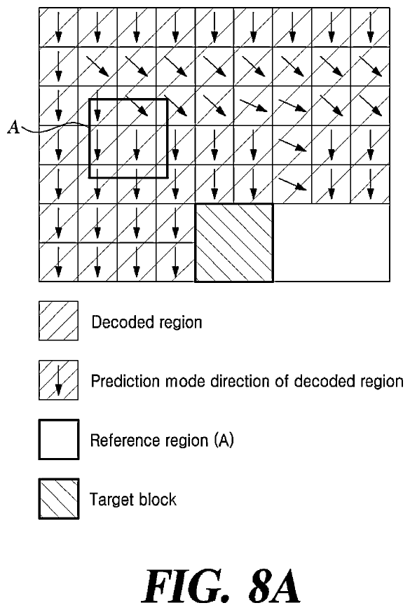

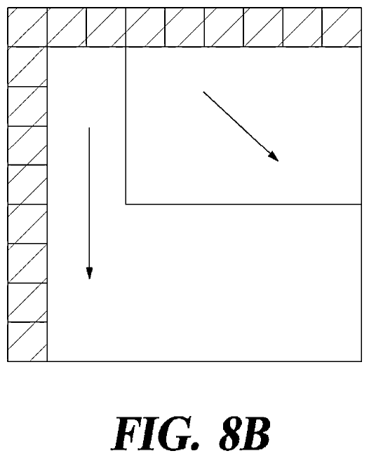

Referring to FIG. 8A, vertical directional modes and right downward diagonal modes are stored in a reference region A determined by the first syntax element. Intra-prediction modes in the reference region may be classified into a first category including the vertical directional modes and a second category including the right downward diagonal modes. Accordingly, as shown in FIG. 8B, the video decoding apparatus may split the target block into subblocks corresponding to the first category and subblocks corresponding to the second category.

In another embodiment for determining a splitting type of the target block, the second syntax element may be used along with the first syntax element. In this embodiment, the splitting type determined by the first syntax element is a prediction splitting type of the target block. In other words, the first syntax element is information showing a reference region to be referenced to predict the splitting type of the target block. Meanwhile, the second syntax element is information showing an index difference.

The video decoding apparatus determines a reference region within the current picture by using the first syntax element. Also, the video decoding apparatus determines a prediction splitting type of the target block among a plurality of defined splitting types defined by using the decoded information corresponding to the reference region. Here, the plurality of splitting types may include types that split the target block into a plurality of subblocks by one or more splitting boundary lines among a vertical line, a horizontal line, a diagonal line, or a curved line. The plurality of splitting types may be fixed and preset in the video encoding apparatus and the video decoding apparatus. Alternatively, after determining the plurality of splitting types, the video encoding apparatus may signal the plurality of splitting types to the video decoding apparatus by using an SPS, a PPS, a slice header, etc.

The video decoding apparatus derives an index corresponding to a splitting type of the target block by adding an index difference defined by the second syntax element to an index corresponding to a prediction splitting type. A splitting type indicated by the derived index, among the plurality of splitting types, is determined as the splitting type of the target block.

According to this embodiment, the amount of bits required to encode information on the splitting type of the target block among the plurality of splitting types may be reduced. In this embodiment, the splitting type of the target block is predicted by the first syntax element, and an index difference between an index corresponding to the predicted splitting type and an index corresponding to the actual splitting type of the target block is encoded. Thus, encoding efficiency may be improved.

In another embodiment for determining a splitting type of the target block, the second syntax element may be used. In this embodiment, the second syntax element may be information directly showing the splitting type of the target block. For example, the second syntax element may be an index for selecting one of the plurality of defined splitting types, and the video decoding apparatus may determine a splitting type indicated by the second syntax element among the plurality of splitting types as the splitting type of the target block.

2. Determination of Block Vector

Once the splitting type of the target block is determined in the above-described manner, the video decoding apparatus decodes block vector information on one or more subblocks into which the target block is split according to the splitting type. The block vector information may be a block vector difference between the actual block vector of each subblock and the aforementioned initial block vector. For each subblock, the video decoding apparatus calculates a block vector corresponding to that subblock by adding the block vector difference and the initial block vector.

The block vector difference for the first subblock to be decoded among the plurality of subblocks may not be included in the block vector information. In this case, the block vector difference of the first subblock is set to 0, and thus the block vector of the first subblock is set to the initial block vector.

Meanwhile, in an embodiment in which the splitting type of the target block is determined only by the second syntax element showing an index for selecting one of the plurality of defined splitting types, the initial block vector does not exist. In this embodiment, the block vector information may include the block vector of the first subblock and a difference (block vector difference) between the block vector of the first subblock and the block vector of a subblock other than the first subblock. The video decoding apparatus decodes the block vector of the first subblock and derives the block vector of another subblock by adding a difference with the block vector of the first subblock. Alternatively, the block vector information may include an index for selecting a predicted block vector among block vector candidates derived from neighboring blocks of the target block and a block vector difference for each subblock showing a difference between the predicted block vector and the actual block vector of a corresponding subblock. After deriving block vector candidates from the neighboring blocks of the target block, the video decoding apparatus sets a candidate indicated by the index as a predicted block vector and determines a block vector corresponding to each subblock by adding the predicted block and the block vector difference.

3. Generation of Prediction Block of Target Block

The video decoding apparatus generates one or more prediction blocks by using the block vectors of the subblocks and combines the prediction blocks to generate a prediction block for the target block.

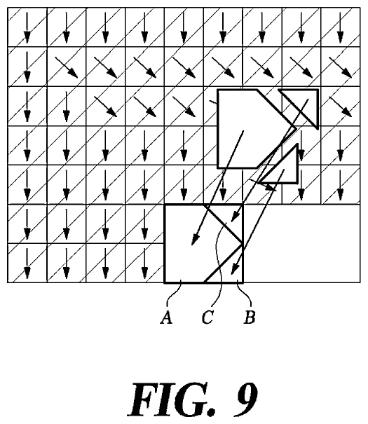

In one embodiment, the video decoding apparatus generates a prediction block for each subblock, identical in size and shape to the subblock, by using the block vector of the subblock. The prediction blocks of the subblocks are combined to generate a prediction block of the target block. For example, referring to FIG. 9, the video decoding apparatus generates a prediction block identical in size and shape to Subblock A from a reconstructed region within the current picture by using the block vector of Subblock A into which the target block is split. Prediction blocks for Subblocks B and C are generated in the same manner. The prediction blocks of Subblocks A to C are combined to generate a prediction block of the target block.

In another embodiment, the video decoding apparatus may generate one or more prediction blocks identical in size and shape to the target block from a reconstructed region within the current picture by using the block vectors corresponding the subblocks. The video decoding apparatus generates the prediction block of the target block by calculating the weighted average of the prediction blocks generated using the block vectors. For example, Prediction Block (i, j) of the target block may be generated by using Equation 1:

B(i,j)=(sub_B₁(i,j)*W₁(i,j)+sub_B₂(i,j)*W₂(i,j)+ . . . +sub_B_{N}(i,j)*W_{N}(i,j))<<p [Equation 1]

Here, i and j represent the position of the pixel. If the width of the target block is denoted by L and its height is denoted by M, i and j have a value of 0˜L−1 and a value of 0˜M−1, respectively. sub_Bk(i, j) represents the pixel value of the (i, j) position in a k-th L×M prediction block generated using a block vector corresponding to a k-th subblock, and Wk(i, j) represents a weight corresponding to the (i, j) position in the k-th prediction block. “<<p” means a shift operation for dividing the sum of weighted values of sub_Bk(i, j) (k=0, 1, . . . , N) by the sum of the weights when the sum of the weights is 2^{p}.

A larger weight value is assigned to the pixels in the region corresponding to the k-th subblock in the kth L×M prediction block, and the closer the pixels are toward the boundary of the subblock the smaller the weight becomes. A smaller weight value is assigned to a region other than the k-th subblock in the k-th L×M prediction block compared to the region corresponding to the k-th subblock. The farther away each pixel in the region other than the k-th subblock is from the boundary of the subblock, the smaller the weight assigned to each pixel position becomes.

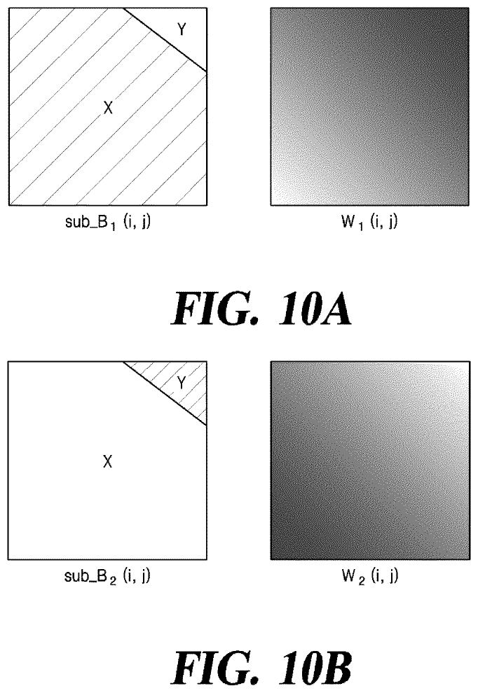

FIG. 10 is a view for explaining weights assigned to prediction blocks derived from block vectors corresponding to subblocks according to an embodiment of the present disclosure. Suppose that a target block with a size of L×M is split into Subblock X and Subblock Y. The video decoding apparatus generates a prediction block sub_B₁ with a size of L×M from a block vector corresponding to Subblock X and generates a prediction block sub_B₂ with a size of L×M from a block vector corresponding to Subblock Y.

FIG. 10A shows a weight W₁ corresponding to each pixel position within a prediction block sub_B₁, and FIG. 10B shows a weight W₂ corresponding to each pixel position within a prediction block sub_B₂. In FIGS. 10A and 10B, the values of the weights are indicated by light and dark tones. A darker tone means a smaller weight value. In other words, the weight may increase gradually from 0 to 1 as the color goes from black to white.

Referring to FIG. 10A, since the prediction block sub_B₁ is generated from the block vector of Subblock X, higher weight values are assigned to the region corresponding to Subblock X within the prediction block sub_B₁, and lower weight values are assigned to the region corresponding to Subblock Y. Referring to FIG. 10B, since the prediction block sub_B₂ is generated from the block vector of Subblock Y, higher weight values are assigned to the region corresponding to Subblock Y within the prediction block sub_B₂, and lower weight values are assigned to the region corresponding to Subblock X.

In the above, a method of performing prediction by splitting a target block into various certain shapes in the IBC mode has been described. This method may be applied when the width and height of the target block are greater than a preset threshold. The threshold may be set to different values for width and height, respectively or set to the same value.

Although the flow diagrams according to the present embodiment are described so that each process therein is sequentially executed, the present disclosure is not limited to the specific description. In other words, since it may be applicable to execute the steps described in the flow diagrams after changing the execution order thereof or to execute one or more steps in parallel, the flow diagrams are not limited to a sequential order of execution.

It should be understood that the embodiments described above may be implemented in many different ways. The functions described in one or more examples may be implemented in hardware, software, firmware, or any combination thereof. It should be understood that the functional components described herein have been labeled “unit” to further emphasize their implementation independence.

Meanwhile, various functions or methods of the present disclosure may be implemented as instructions stored in a non-transitory recording medium that may be read and executed by one or more processors. Non-transitory recording media include, for example, all types of recording devices in which data is stored in a form readable by a computer system. For example, the non-transitory recording medium includes storage media, such as an erasable programmable read only memory (EPROM), a flash drive, an optical drive, a magnetic hard drive, and a solid state drive (SSD).

The above description merely illustrates the technical idea of the present disclosure, and those having ordinary skill in the art to which the present disclosure pertains may make various modifications and changes without departing from the essential characteristics of the present disclosure. Therefore, the embodiments disclosed in the present disclosure are not intended to limit the technical idea of the present disclosure but to describe the present disclosure. The scope of the technical idea of the present disclosure is not limited thereto. The protection scope of the present disclosure should be interpreted by the claims, and all technical ideas within the equivalent scope should be interpreted as being included in the scope of the present disclosure.

1. A method for decoding a target block encoded in an intra block copy (IBC) mode, the method comprising:
determining a splitting type of the target block by decoding at least either a first syntax element for determining a reference region to be referenced to split the target block or a second syntax element related to the splitting type of the target block;
decoding block vector information on one or more subblocks into which the target block is split according to the splitting type[H] and determining block vectors respectively corresponding to the subblocks by using the block vector information; and
predicting the target block by generating and combining one or more prediction blocks from a current picture where the target block is positioned, by using the block vectors respectively corresponding to the subblocks.

2. The method of claim 1, wherein the determining of the splitting type of the target block includes:
determining the reference region within the current picture by using the first syntax element; and
deriving the splitting type of the target block by using decoded information corresponding to the reference region,
wherein the decoded information corresponding to the reference region is splitting information showing a splitting type of the reference region or intra-prediction modes corresponding to the reference region.

3. The method of claim 2, wherein the first syntax element is an initial block vector indicating the reference region within the current picture.

4. The method of claim 2, wherein the first syntax element is an index for selecting one of block vector candidates derived from decoded blocks which are decoded prior to the target block, and
wherein the deriving of the splitting type of the target block includes:
selecting an initial block vector from the block vector candidates by using the index; and
determining the reference region by using the initial block vector and determining the splitting type of the target block by using the decoded information corresponding to the reference region.

5. The method of claim 3, wherein the block vector information shows block vector differences between the block vectors respectively corresponding to the subblocks and the initial block vector.

6. The method of claim 2, wherein the second syntax element is an index difference, and
wherein the deriving of the splitting type of the target block includes:
selecting a prediction splitting type among a plurality of defined splitting types by using the decoded information corresponding to the reference region; and
determining the splitting type of the target block among the plurality of splitting types by adding the index difference to an index corresponding to the prediction splitting type.

7. A method for encoding a target block using an intra block copy (IBC) mode, the method comprising:
determining a splitting type of the target block;
determining block vectors for one or more subblocks into which the target block is split according to the splitting type;
predicting the target block by generating and combining one or more prediction blocks from a current picture where the target block is positioned, by using the block vectors respectively corresponding to the subblocks; and
encoding information on the splitting type and block vector information on the one or more subblocks,
wherein the information on the splitting type includes at least either a first syntax element for determining a reference region to be referenced to split the target block or a second syntax element related to the splitting type of the target block.

8. The method of claim 7, wherein the splitting type of the target block is determined to be same as a splitting type derived from encoded information corresponding to the reference region, which is determined by the first syntax and positioned within the current picture, and
wherein the encoded information corresponding to the reference region is information showing a splitting type of the reference region or intra-prediction modes corresponding to the reference region.

9. The method of claim 8, wherein the first syntax element is an initial block vector indicating the reference region within the current picture.

10. The method of claim 8, wherein the first syntax element is an index for selecting one of block vector candidates derived from encoded blocks which are encoded prior to the target block, and the reference region is indicated by an initial block vector selected from the block vector candidates by using the index.

11. The method of claim 9, wherein the block vector information shows block vector differences between the block vectors respectively corresponding to the subblocks and the initial block vector.

12. The method of claim 8, wherein the encoding of the second syntax element includes:
selecting a prediction splitting type among a plurality of defined splitting types by using decoded information corresponding to the reference region; and
determining the splitting type of the target block among the plurality of splitting types by adding an index difference to an index corresponding to the prediction splitting type.

13. A decoder-readable recording medium for storing a bitstream which includes encoded data of a target block encoded using an intra block copy (IBC) mode and is decoded by a video decoding method, the video decoding method comprising:
determining a splitting type of the target block by decoding at least either a first syntax element for determining a reference region to be referenced to split the target block or a second syntax element related to the splitting type of the target block;
decoding block vector information on one or more subblocks into which the target block is split according to the splitting type and determining block vectors respectively corresponding to the subblocks by using the block vector information; and
predicting the target block by generating and combining one or more prediction blocks from a current picture where the target block is positioned, by using the block vectors respectively corresponding to the subblocks.
